(19) United States
(12) Patent Application Publication
(10) Pub. No.: US 2019/0072886 A1
(43) Pub. Date: Mar. 7, 2019

(54) IMAGE PROCESSING APPARATUS WITH HEATING APPARATUS

(71) Applicants: KABUSHIKI KAISHA TOSHIBA, Tokyo (JP); TOSHIBA TEC KABUSHIKI KAISHA, Tokyo (JP)

(72) Inventor: Hiroyuki Fuse, Sunto Shizuoka (JP)

(21) Appl. No.: 15/694,349

(22) Filed: Sep. 1, 2017

(51) Int. Cl. G03G 15/20

(52) U.S. Cl. CPC G03G 15/2039; G03G 15/80

(57) ABSTRACT

A heating apparatus for use in an image processing apparatus includes a heat roller configured to apply heat to a transported sheet. A heating unit provided in the heat roller heats the heat roller. A controller controls a current applied from an alternating current (AC) power supply to the heating unit. The current is supplied to the heating unit according a predetermined control pattern including a plurality of steps during each of which the current flows or does not flow through the heating unit depending on a duty ratio of the heating unit. The predetermined control pattern is repeated in accordance with a polarity equalization control so that a polarity ratio of a timing in which a current of positive polarity flows through the heating unit and a timing in which a current of negative polarity flows through the heating unit is 1.

### FIELD

Embodiment described herein relates generally to an image processing apparatus with a heating apparatus.

### BACKGROUND

In general, temperature control of a fixer of an image processing apparatus is typically performed based on two target temperatures of an upper limit temperature and a lower limit temperature at which an appropriate fixing performance can be obtained. A heating unit is controlled to be “on” until a temperature of the fixer becomes the upper limit temperature and when the temperature reaches the upper limit temperature, the heating unit is turned “off.” After the heating unit is turned “off,” the temperature starts to fall after overshooting for a while. Even when the temperature falls below the upper limit temperature, the heating unit is maintained in the “off” state. When the temperature reaches the lower limit temperature, the heating unit is turned “on”. After the heating unit is turned “on”, the temperature starts to rise after undershooting for a while. After the temperature exceeds the lower limit temperature, the heating unit remains “on”, and when the temperature reaches the upper limit temperature, the heating unit is turned “off”. By repeating such a process, the temperature of the fixer is controlled. Even if the upper limit temperature and the lower limit temperature are the same, the temperature of the fixer is controlled in the same manner.

However, in such temperature control regimes, the range of the temperature of the fixer is large and thus accuracy of temperature control is reduced. Even when the upper limit temperature and the lower limit temperature are the same, the range of the temperature of the fixer may be too large due to overshoot and undershoot, and accuracy of temperature control is reduced in the same manner. In order to decrease the range, instead of controlling “on” or “off” of the heating unit at a duty ratio of 100%, the heating unit may be controlled at duty ratios of a plurality of values between 0% and 100%.

However, when “on” or “off” of the heating unit is controlled at the duty ratios between 0% and 100%, a lifetime of the heating unit may be shortened.

### DESCRIPTION OF THE DRAWINGS

FIG. 1 is an exterior view illustrating an example configuration of an image processing apparatus according to an embodiment.

FIG. 2 is a schematic diagram illustrating an example configuration of a fixing unit included in a printer.

FIG. 3 is a diagram illustrating an example control circuit of a heat source of the image processing apparatus.

FIG. 4 is a diagram illustrating an example of a control pattern.

FIG. 5 is a diagram illustrating an example of a current flow pattern through the heat source and polarity of the current flow based on the control pattern illustrated in FIG. 4.

FIG. 6 is a diagram illustrating insert ion of an adjustment period into the current flow pattern.

FIG. 7 is a diagram schematically illustrating reversal of the order of the current flow pattern.

FIG. 8 is a diagram illustrating an example of a current flow pattern through the heat source and polarity of the current flow when the inverse order is executed.

FIG. 9 is a diagram illustrating changing a starting point of the control pattern.

### DETAILED DESCRIPTION

According to an embodiment, a heating apparatus for use in an image processing apparatus includes a heat roller configured to apply heat to a transported sheet. A heating unit provided in the heat roller heats the heat roller. A controller controls a current applied from an alternating current (AC) power supply to the heating unit. The current is supplied to the heating unit according a predetermined control pattern including a plurality of steps during each of which the current flows or does not flow through the heating unit depending on a duty ratio of the heating unit. The predetermined control pattern is repeated in accordance with a polarity equalization control so that a polarity ratio of a timing in which a current of positive polarity flows through the heating unit and a timing in which a current of negative polarity flows through the heating unit is 1.

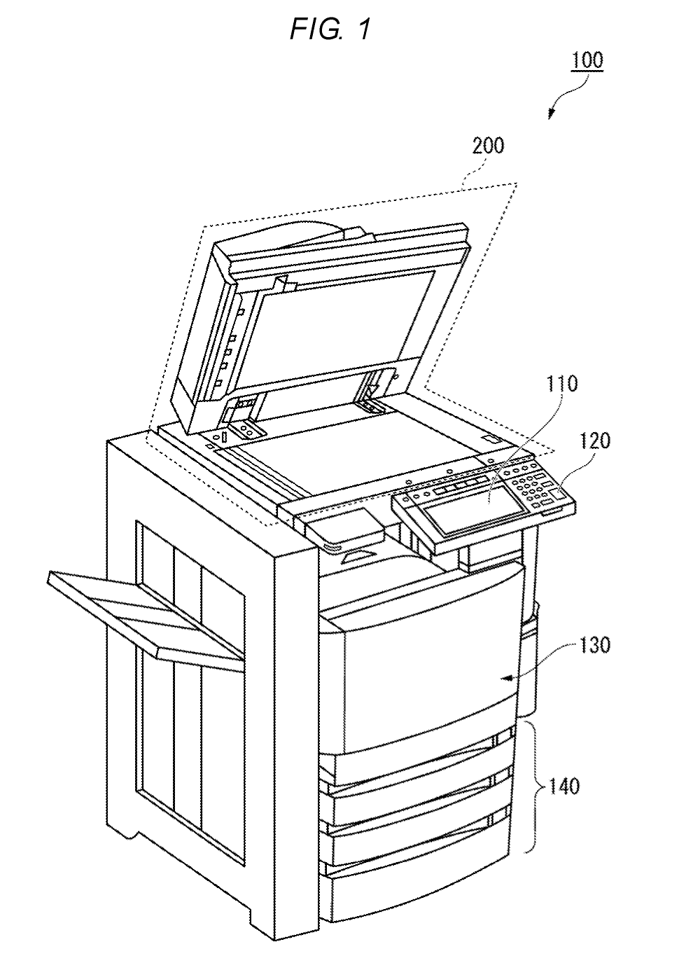

FIG. 1 is an exterior view illustrating an example configuration of an image processing apparatus 100 according to an embodiment. The image processing apparatus 100 may be an apparatus for forming an image on a sheet, such as a multifunction printer. The image processing apparatus 100 may be an apparatus for decoloring an image formed on a sheet by heat, such as a decoloring apparatus. Hereinafter, a case where the image processing apparatus 100 is a multifunction printer will be described as an example. If the image processing apparatus 100 is the multifunction printer, the heating unit is provided in a fixing unit. If the image processing apparatus 100 is the decoloring apparatus, the heating unit may be provided in a decoloring unit.

The image processing apparatus 100 includes a display 110, a control panel 120, a printer 130, a sheet storing unit 140, and an image reading unit 200.

The image processing apparatus 100 forms an image on a sheet using developer such as a toner or the like. The sheet is, for example, paper or label paper. Any sheet may be used as long as the image processing apparatus 100 can form an image on a surface of the sheet.

The display 110 is an image display device such as a liquid crystal display, an organic EL (Electro Luminescence) display, or the like. The display 110 displays various types of information related to the image processing apparatus 100.

The control panel 120 includes a plurality of buttons. The control panel 120 receives a user's instruction. The control panel 120 outputs signal according to the instruction input by the user to the controller of the image processing apparatus 100. The display 110 and the control panel 120 may be integrated as an touch panel.

The printer 130 forms an image on a sheet based on image information generated by the image reading unit 200 and image information received via a communication path. The printer 130 forms an image by the following process, for example. An image forming unit of the printer 130 forms an electrostatic latent image on a photoconductive drum based on image information. The image forming unit of the printer 130 forms a visible image by applying developer to the electrostatic latent image. A specific example of the developer is toner. A transfer unit of the printer 130 transfers the visible image to a sheet. A fixing unit of the printer 130 fixes the visible image on the sheet by applying heat and pressure to the sheet. The sheet on which the image is formed may be a sheet conveyed from the sheet storing unit 140 or a manually fed sheet.

The sheet storing unit 140 accommodates a sheet used for forming an image in the printer 130.

The image reading unit 200 generates image information by imaging a reading target. The image reading unit 200 records the generated image information. The image information may be transmitted to other information processing devices via network. The recorded image information may be used for forming an image on a sheet by the printer 130.

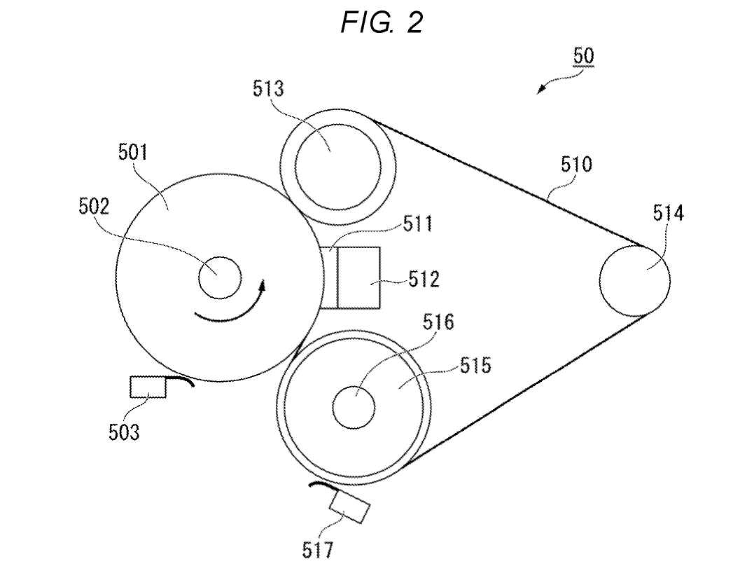

FIG. 2 is a schematic diagram illustrating an example configuration of a fixing unit 50 included in the printer 130. The fixing unit 50 is an example of a heating apparatus according to an embodiment. The fixing unit 50 includes a heat roller 501, a heat source 502, a thermistor 503, a pressure belt 510, a pressure pad 511, a pad holder 512, a pressure roller 513, a tension roller 514, a belt heat roller 515, a pressure belt heat source 516, and a pressure thermistor 517.

The heat roller 501 is formed in a cylindrical shape. The heat source 502 is the heating unit provided inside the heat roller 501. The heat source 502 may be, for example, a halogen lamp. The heat source 502 generates heat by being controlled to turn “on” by a controller 60. The heat source 502 heats the heat roller 501 by generating heat. The thermistor 503 measures a surface temperature of the heat roller 501.

The pressure belt 510 extends around the pressure roller 513, the tension roller 514, and the belt heat roller 515. The pressure belt 510 applies contact-pressure to the heat roller 501 by the pressure pad 511 and the pressure roller 513. By this contact pressure, a fixing nip portion is formed between the pressure belt 510 and the heat roller 501.

The pressure pad 511 applies the contact pressure to the heat roller 501 via the pressure belt 510. The pad holder 512 is maintained in a state where the pressure pad 511 applies the contact pressure with the heat roller 501.

The pressure roller 513 is positioned downstream of the heat roller 501 in a transport direction of a sheet. The pressure roller 513 causes the pressure belt 510 to apply contact pressure to the heat roller 501. An exit of the fixing nip portion is formed by the pressure roller 513. The tension roller 514 provides tension to the pressure belt 510 by being arranged a position separated from the pressure roller 513 and the belt heat roller 515. The belt heat roller 515 is arranged upstream of the heat roller 501 in a transport direction of the sheet. The belt heat roller 515 has a hollow cylindrical shape. The pressure belt heat source 516 is provided inside the belt heat roller 515. The pressure belt heat source 516 heats the belt heat roller 515 by generating heat. The pressure belt heat source 516 may be, for example, a halogen lamp. The pressure thermistor 517 measures a surface temperature of the pressure belt 510 in a periphery of the belt heat roller 515.

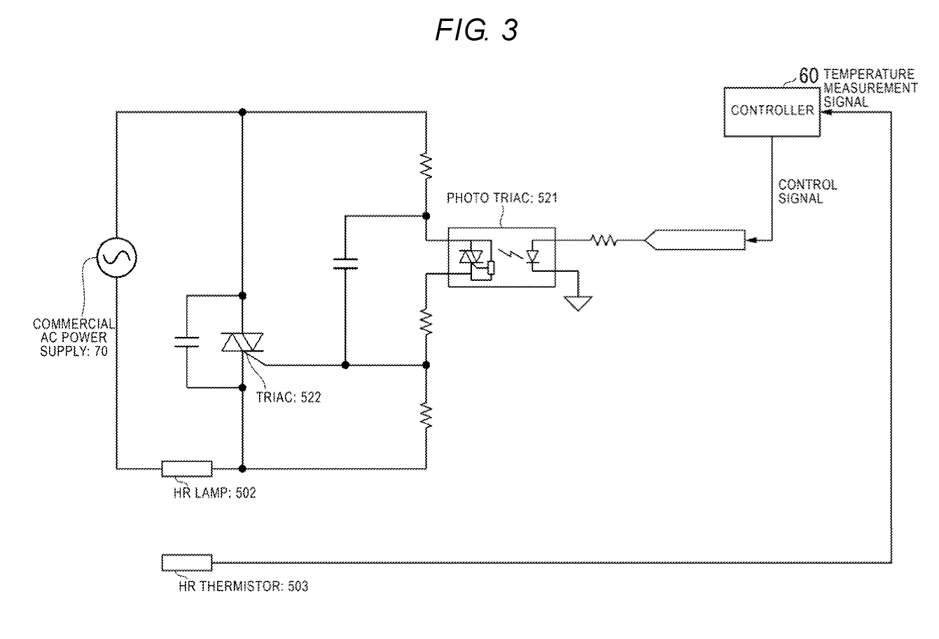

FIG. 3 is a diagram illustrating an example control circuit of the heat source 502 of the image processing apparatus 100. A control signal output from the controller 60 is input to the control circuit. The control signal is a signal indicating that the heat source 502 is turned “on” or “off”. A photo triac 521 is provided in the control circuit. The photo triac 521 controls timing for the control signal output from the controller 60 to control “on” or “off” of the heat source 502 at a timing of zero-crossing. A commercial alternating current (AC) power supply 70 is connected to the control circuit. Electric power is supplied from the AC power supply 70 to the heat source 502. The controller 60 executes control of timing during which a waveform of the AC power supply 70 becomes zero-crossing by the photo triac 521.

When a control signal indicating “on” is output from the controller 60, a triac 522 turns on “on” at timing of the next zero-crossing when electric power is supplied from the AC power supply 70 to the heat source 502. When a control signal indicating “off” is output from the controller 60, a triac 522 turns “off” at timing of the next zero-crossing when electric power supply from the AC power supply 70 to the heat source 502 is stopped.

A temperature measurement signal output from the thermistor 503 is input to the controller 60. The temperature measurement signal indicates a result of the thermistor 503 measuring a temperature in a periphery of the heat source 502. The controller 60 determines whether the heat source 502 is “on” or “off” base on the result of measuring the temperature. For example, a temperature measurement result is stored in correspondence with a duty ratio in advance, and the controller 60 determines the duty ratio based on the measurement result according to the correspondence. The controller 60 outputs a control signal indicating “on” or “off” to the control circuit based on the control pattern according to the determined duty ratio.

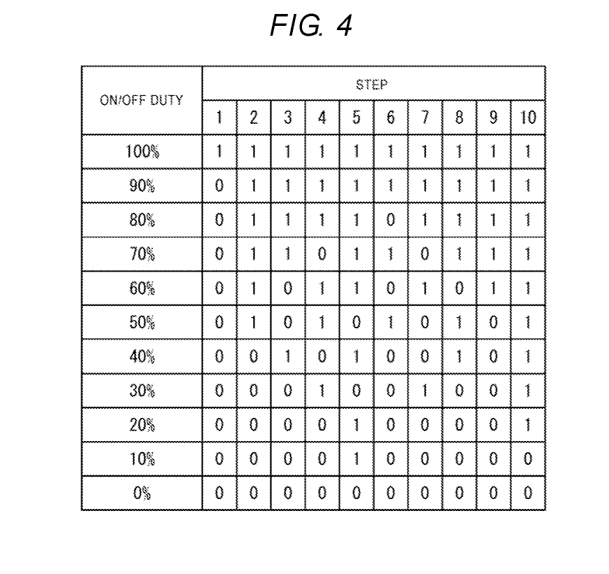

FIG. 4 is a diagram illustrating an example of the control pattern. In the example illustrated in FIG. 4, a length of 5 cycles of an AC power supply corresponds to a cycle of the control pattern (hereinafter, referred to as “pattern cycle”). One cycle of the control pattern includes a plurality of steps (for example, 10 steps). In the example in FIG. 4, the number of steps included in one cycle of the control pattern is 10. For this reason, in the example in FIG. 4, a length of half cycle of a waveform of the AC power supply corresponds to one step of the control pattern. In the example control pattern illustrated in FIG. 4, “0” indicates “off” and “1” indicates “on.” In the control pattern illustrated in FIG. 4, a control pattern is defined according to duty ratios incremented by 10%, from 0% (always OFF) to 100% (always ON). For example, when duty control of 10% is executed, the heat source 50 is controlled to be “off” for the first 2 cycles of the AC power supply. The heat source 50 is controlled to be “on” from 2 cycles to 2.5 cycles of the AC power supply, and controlled to be “off” from 2.5 cycles to 5 cycles of the AC power supply. By such control, the heat source 50 is “on” for only 0.5 cycle among 5 cycles of the AC power supply in accordance with the control pattern. In this manner, a duty ratio of 10% is realized.

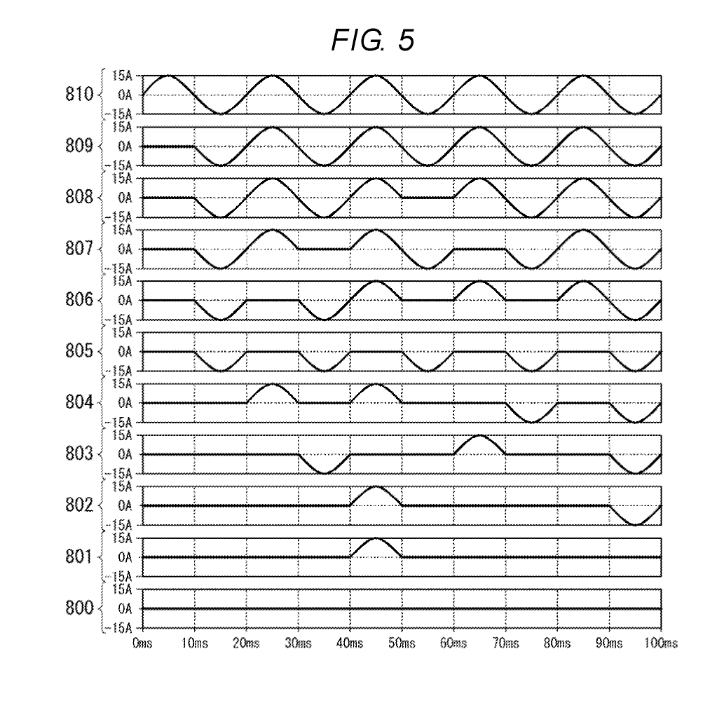

FIG. 5 is a diagram illustrating a current flow pattern through the heat source 502 and polarity of the flowing current when the control pattern illustrated in FIG. 4 is executed. A waveform illustrated in FIG. 5 is a waveform if an AC power supply used is 50 Hz and a cycle of one step is 10 milliseconds (ms). Waveforms 800 to 810 are respectively waveforms of currents supplied to the heat source 50 for duty ratios from 0% to 100%. For example, when a duty ratio of 10% is executed, no current flows through the heat source 50 during the first 2 cycles (0 ms to 40 ms) of the AC power supply. A current of positive polarity flows through the heat source 502 between 2 cycles and 2.5 cycles (between 40 ms and 50 ms). No current flows between 2.5 cycles and 5 cycles (between 50 ms and 100 ms). By such control, since a current flows to the heat source 50 for only 10 ms out of 100 ms, a duty ratio of 10% is realized.

The controller 60 executes a control (hereinafter, referred to as “polarity equalization control”) so that a difference between time during which a current with positive polarity flows through the heat source 502 and the time during which a current with negative polarity flows through the heat source 502 is reduced by the control pattern. In other words, the control pattern is repeated in accordance with the polarity equalization control so that a ratio of a timing in which a current of positive polarity flows through the heating unit and a timing in which the a current of negative polarity flows through the heating unit is approximately 1. Hereinafter, three specific examples of polarity equalization control will be described.

### Adjustment Period Insertion Method

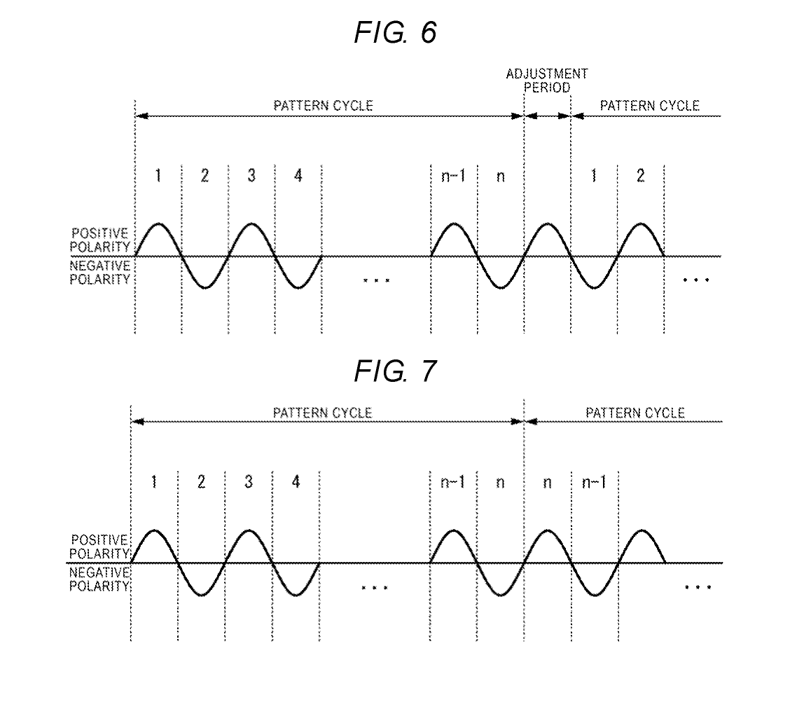

First, an adjustment period insertion method will be described. FIG. 6 is a diagram schematically illustrating insertion of an adjustment period into the current flow pattern. In an example in FIG. 6, an AC power supply used is 50 Hz and a cycle of one step is 10 ms. Thus, the polarity of current changes every 10 ms.

In the adjustment period insertion method, the controller 60 inserts an adjustment period with a predetermined length between a specific pattern cycle and a next pattern cycle. The adjustment period is a period in which the polarity of the current in a specific pattern cycle is opposite to the polarity of the current in the next pattern cycle. If the pattern cycle has an even number of steps, a period having an odd number of steps may be inserted as an adjustment period. For example, in FIG. 6, if the number of steps n=10, an adjustment period corresponding to one step may be inserted at the end of the pattern cycle. In this case, although the polarity of the first step of the pattern cycle illustrated at a beginning in FIG. 6 is positive, the polarity of the first step of the pattern cycle after the adjustment period is inserted is negative polarity.

The timing at which the adjustment period is inserted may be a period which is an integer multiple of a pattern period. For example, an adjustment period may be inserted every time one pattern cycle is ended or an adjustment period may be inserted every time two pattern cycles are ended. A length of an adjustment period may be not limited to one step. For example, the length of the adjustment period may be three steps or five steps.

By inserting such a adjustment period, polarity of the current in each of the steps in the pattern cycle changes after the adjustment period is inserted. Particularly, as illustrated in FIG. 6, in the first pattern cycle, steps corresponding to an odd multiple of ½ cycles of the AC power supply 70 have positive polarity, and in the second pattern cycle, steps corresponding to odd multiples of ½ cycles of the AC power supply 70 have negative polarity. In this manner, it is possible to execute control so that a difference between time during which a current with positive polarity flows through the heat source 502 and the time during which a current with negative polarity flows through the heat source 502 is reduced. In other words, the control pattern is repeated after inserting the adjustment period so that a ratio of a timing in which a current of positive polarity flows through the heating unit and a timing in which a current of negative polarity flows through the heating unit is approximately 1. As a result, it is possible to increase a lifetime of the heat source 502.

### Inverse Order Method

Next, an inverse order method will be described. FIG. 7 is a diagram schematically illustrating reversing the order of the current flow pattern. In the inverse order method, the controller 60 reverses the order of each step from one pattern cycle to the next pattern cycle. For example, if control is executed in order of step 1 to step n in one pattern cycle, control is executed in order of step n to step 1 in the next pattern cycle. By performing such control, control of steps n is executed twice consecutively. In this manner, polarity changes from a first step n in the first pattern cycle to a second step n in the next pattern cycle. Particularly, as illustrated in FIG. 7, in the first pattern cycle, steps corresponds to an odd multiple of ½ cycles of the AC power supply 70 have positive polarity, and in the second pattern cycle, steps corresponding to odd multiples of ½ cycles of the AC power supply 70 have negative polarity. The same applies to a step n-1 and the following steps.

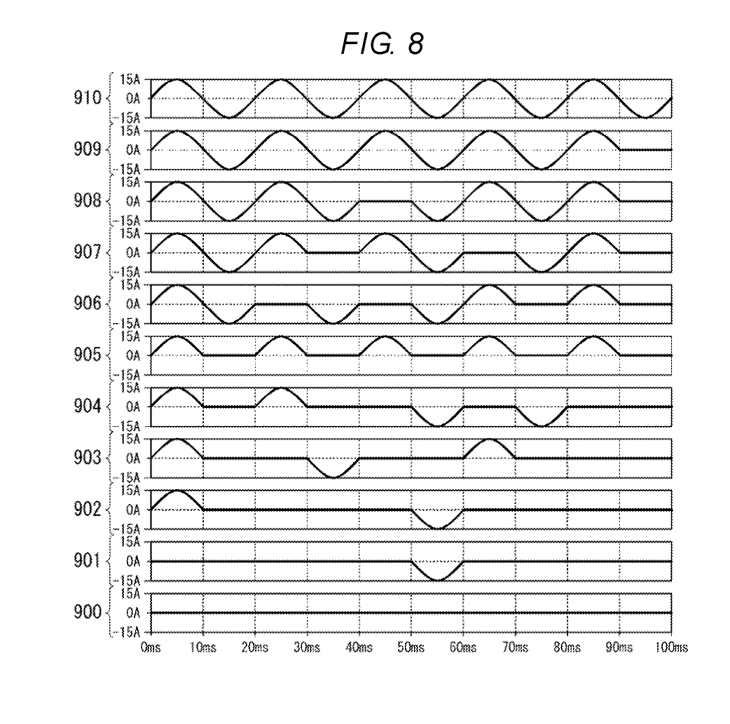

FIG. 8 is a diagram illustrating an example of a current flow pattern through the heat source 502 and polarity of the current flow when the inverse order is executed. Waveforms 900 to 910 are respectively waveforms of current supplied to the heat source 502 for duty ratios in 10% increments from 0% to 100%. In FIG. 8, step n of the pattern cycle corresponds to 0 ms to 10 ms, step n-1 of the pattern cycle corresponds to 10 ms to 20 ms, and so on, with step 1 of the pattern cycle corresponding to 90 ms to 100 ms. In FIG. 5, step n of the pattern cycle corresponds to 90 ms to 100 ms, step n-1 of the pattern cycle corresponds to 80 ms to 90 ms, and so on, with step 1 of the pattern cycle corresponding to 0 ms to 10 ms. Thus, in the waveform illustrated in FIG. 5 and the waveform illustrated in FIG. 8, polarities of currents at timing of “on” are reversed. For this reason, it is possible to execute control so that a difference between time during which a current with positive polarity flows through the heat source 502 and the time during which a current with negative polarity flows through the heat source 502 is reduced. In other words, the control pattern is inversely repeated so that a ratio of a timing in which a current of positive polarity flows through the heating unit and a timing in which a current of negative polarity flows through the heating unit is approximately 1. As a result, it is possible to increase of a lifetime of the heat source 502.

### Starting Point Change Method

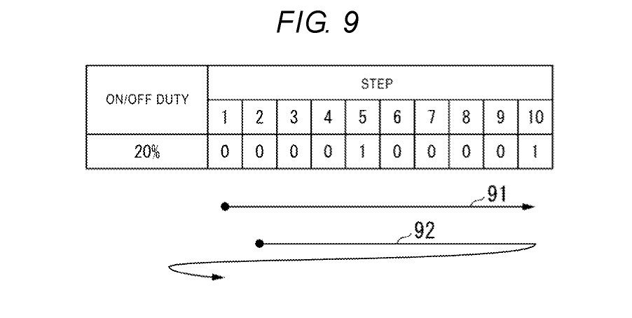

Next, a starting point change method will be described. FIG. 9 is a diagram schematically illustrating changing the starting point of the control pattern. In the starting point change method, a starting point of the first step of the control pattern executed in one pattern cycle is different from the first step of the control pattern of the next pattern cycle. In a specific example in FIG. 9, step 1 is a starting point in the pattern cycle indicated by an arrow 91 and the following steps are sequentially executed until step 10. On the other hand, step 2 is a starting point in the next pattern cycle indicated by an arrow 92 and the following steps are sequentially executed until step 10. After step 10, step 1 is executed. In this way, in the starting point change method, a step which is a starting point in the first cycle is changed in the next cycle. All steps are cyclically executed in order. For example, if the number of steps is an even number, by changing a step which is a starting point to an odd number, polarity of a current at timing of “on” changes. Particularly, in the first pattern cycle, steps corresponding to an odd multiple of ½ cycles of the AC power supply 70 have positive polarity, and in the second pattern cycle, steps corresponding to odd multiples of ½ cycles of the AC power supply 70 have negative polarity. For this reason, it is possible to execute control so that a difference between time during which a current with positive polarity flows through the heat source 502 and the time during which a current with negative polarity flows through the heat source 502 is reduced. As a result, it is possible to increase a lifetime of the heat source 502.

In the image processing apparatus 100 configured as described above, control is executed so that a difference between time during which a current of positive polarity flows through the heat source 502 and the time during which a current of negative polarity flows through the heat source 502 is reduced. In other words, the control pattern is repeated with a change in the step which is the starting point so that a ratio of a timing in which a current of positive polarity flows through the heating unit and a timing in which a current of negative polarity flows through the heating unit is approximately 1. For this reason, it is possible to increase a lifetime of the heat source 502.

### Modification Example

In the embodiment described above, a pattern cycle is five times a cycle of the AC power supply, but the pattern period is not necessarily configured as such. For example, a cycle of the AC power supply may correspond to a pattern cycle. In this case, when the number of steps is equal to or more than 3, control at timing of zero-crossing cannot be performed, but the control may be configured as such. For example, the number of steps may be 10 if a cycle of the AC power supply corresponds a pattern cycle.

The controller 60 may be configured so as not to execute polarity equalization control for duty ratios with a small bias in polarity and to execute polarity equalization control for duty ratios with a large bias in polarity. For example, in the example illustrated in FIG. 5, in duty ratios of 0%, 20%, 40%, 60%, 80%, and 100% (hereinafter, referred to as “first duty type”), no bias in polarity occurs within a pattern period. On the other hand, in duty ratios of 10%, 30%, 50%, 70%, and 90% (hereinafter, referred to as “second duty type”), bias in polarity occurs within a pattern period. For this reason, the controller 60 may not execute polarity equalization control for the first duty type, but may execute polarity equalization control in the second duty type.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A heating apparatus for use in an image processing apparatus comprising:
a heat roller configured to apply heat to a transported sheet;
a heating unit positioned in the heat roller and configured to heat the heat roller; and
a controller configured to control a current applied from an alternating current (AC) power supply to the heating unit, the current being supplied to the heating unit according to one of a plurality of predetermined control patterns each including a same number of steps during each of which the current flows or does not flow through the heating unit depending on a duty ratio of the heating unit, the one of the predetermined control patterns being repeated in accordance with a polarity equalization control so that a polarity ratio of a timing in which a current of positive polarity flows through the heating unit and a timing in which a current of negative polarity flows through the heating unit is 1.

2. The apparatus according to claim 1, wherein the polarity equalization control includes inserting an adjustment period with a predetermined length after the one of the predetermined control patterns and then repeating the one of the predetermined control patterns.

3. The apparatus according to claim 2, wherein the adjustment period has a length that is equal to a length corresponding to an odd number of the steps when a total number of the steps included in the one of the predetermined control patterns is an even number.

4. The apparatus according to claim 1, wherein the polarity equalization control includes repeating the one of the predetermined control patterns with the steps in reverse order.

5. The apparatus according to claim 1, wherein the polarity equalization control includes repeating the one of the predetermined control patterns with a change to a starting step in the one of the predetermined control patterns.

6. The apparatus according to claim 5, wherein in repeating the one of the predetermined control patterns, the starting step is shifted by an odd number of steps if the number of the steps included in the control pattern is an even number.

7. The apparatus according to claim 1, wherein each step of the one of the predetermined control patterns corresponds to ½ of one cycle of the AC power supply

8. The apparatus according to claim 1, wherein each step of the one of the predetermined control patterns starts at a zero-crossing of the AC power supply.

9. The apparatus according to claim 1, wherein a duration of the one of the predetermined control patterns is an integer multiple of a frequency cycle of the AC power supply.

10. The apparatus according to claim 1, wherein:
each of the predetermined control patterns corresponds to a different duty ratio,
the controller does not apply the polarity equalization control for a control pattern in which the polarity ratio is approximately 1 before applying the polarity equalization control, and
the controller applies the polarity equalization control for a control pattern in which the polarity ratio is substantially different than 1 before applying the polarity equalization control.

11. A method of heating a sheet in an image processing apparatus, the method comprising:
conveying a sheet to a nip formed with at least a heat roller heated by a heating unit;
controlling a current applied from an alternating current (AC) power supply to the heating unit, the current being supplied to the heating unit according to one of a plurality of predetermined control pattern each including a same number of steps during each of which the current flows or does not flow through the heating unit depending on a duty ratio of the heating unit, the one of the predetermined control patterns being repeated in accordance with a polarity equalization control so that a polarity ratio of a timing in which a current of positive polarity flows through the heating unit and a timing in which a current of negative polarity flows through the heating unit is 1; and
heating the sheet with the heat roller as the sheet is conveyed though the nip while the current is supplied to the heating unit according to the one of the predetermined control patterns and the polarity equalization control.

12. The method according to claim 11, wherein the polarity equalization control includes inserting an adjustment period with a predetermined length after the one of the predetermined control patterns and then repeating the one of the predetermined control patterns.

13. The method according to claim 12, wherein the adjustment period has a length that is equal to a length corresponding to an odd number of the steps and a total number of the steps included in the one of the predetermined control patterns is an even number.

14. The method according to claim 11, wherein the polarity equalization control includes repeating the one of the predetermined control patterns with the steps in reverse order.

15. The method according to claim 11, wherein the polarity equalization control includes repeating the one of the predetermined control patterns with a change to a starting step in the one of the predetermined control patterns.

16. The method according to claim 15, wherein in repeating the one of the predetermined control patterns, the starting step is shifted by an odd number of steps if the number of the steps included in the control pattern is an even number.

17. The method according to claim 11, wherein each step of the one of the predetermined control patterns corresponds to ½ of one cycle of the AC power supply

18. The method according to claim 11, wherein each step of the one of the predetermined control patterns starts at a zero-crossing of the AC power supply.

19. The method according to claim 11, wherein a duration of the one of the predetermined control patterns is an integer multiple of a frequency cycle of the AC power supply.

20. The method according to claim 11, wherein the image processing apparatus is one of an image forming apparatus and a decoloring apparatus.
